(19) United States
(12) Patent Application Publication
(10) Pub. No.: US 2006/0126359 A1
(43) Pub. Date: Jun. 15, 2006

(54) Backlight module for outputting high purity white light beams

(75) Inventors: Yen-Chang Yao, Miao-Li (TW); Ching-Tung Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/299,486

(22) Filed: Dec. 12, 2005

(30) Foreign Application Priority Data
Dec. 10, 2004 (TW) 93138293

(51) Int. Cl. F21V 7/04

(52) U.S. Cl. 362/615; 362/555; 362/610

(57) ABSTRACT

A backlight module (20) includes at least a light source (23) for emitting light beams, and a light guide plate (22) having a plurality of colored particles (220) embedded therein. The colored particles have a color complementary to that of the light beams emitted by the light source, whereby the colored particles diffuse and convert the light beams to enable the backlight module to output high purity white light beams.

### FIELD OF THE INVENTION

The present invention relates to backlight modules for use in a liquid crystal display (LCD) or the like, and more particularly to a backlight module enabled to output high purity white light beams.

### BACKGROUND

A typical LCD device includes a liquid crystal display panel, and a backlight system mounted behind the liquid crystal display panel. The backlight system mainly comprises a light source and a light guide plate. The light guide plate is generally made of a transparent acrylic plastic, and is used for guiding the light beams emitted by the light source in order to uniformly illuminate the liquid crystal display panel.

In order to diffuse the light beams and emit them uniformly from a top surface of the light guide plate, protrusions or recesses are provided at a bottom surface of the light guide plate. Alternatively, a pattern of light diffusion dots is formed on the bottom surface of the light guide plate.

Referring to FIG. 4, a conventional backlight module 10 includes a transparent light guide plate 13 and three light emitting diodes (LEDs) 12. The light guide plate 13 includes a light input surface 131, a light output surface 132 adjacent to the light input surface 131, and a bottom surface 133 opposite to the light output surface 132. The LEDs 12 are white light LEDs, which are disposed adjacent to the light input surface 131.

In operation, white light beams emitted from the LEDs 12 enter the light guide plate 13 through the light input surface 131. The light beams are reflected within the light guide plate 13, and are subsequently output from the light output surface 132 of the light guide plate 13. With this configuration, the light beams output from the light output surface 132 provide bright surface illumination.

However, the backlight module 10 does not readily control and maintain the purity of the white light beams emitted from the white light LEDs 12. Therefore, there is a demand for backlight modules to provide greater purity of white surface light. A new backlight module which can meet this demand is desired.

### SUMMARY

In an exemplary embodiment, a backlight module includes a reflector, a plurality of light sources for emitting light beams, and a light guide plate having a plurality of colored particles embedded therein. The color of the particles (e.g., blue) is complementary to that of the light beams emitted by the light sources (e.g., yellow). The colored particles diffuse and convert the light beams input from the light sources via the reflector, to enable the backlight module to output high purity white light beams.

In another exemplary embodiment, a backlight module includes a plurality of light sources for emitting light beams, and a light guide plate. The light guide plate includes a light input surface and a light output surface adjacent to the light input surface. A plurality of colored particles is embedded in the light guide plate. The color of the particles (e.g., blue) is complementary to that of the light beams emitted by the light source (e.g., yellow). The light sources are disposed adjacent to the light input surface. The colored particles convert the light beams emitted by the light sources to high purity white light beams.

With either of these exemplary configurations, the color of the particles and the color of the light beams emitted from the light source are seelected to complement each other, so that when they are mixed together the result is high purity white light.

Other advantages and novel features will become more apparent from the following detailed description when taken in conjunction with the accompanying drawings.

### BRIEF DESCRIPTION OF THE DRAWINGS

FIG. 1 is a schematic, isometric view of a backlight module according to a first embodiment of the present invention, showing essential light paths thereof.

FIG. 2 is a schematic diagram of mixing of colored light beams.

FIG. 3 is a schematic, isometric view of a backlight module according to a second embodiment of the present invention, showing essential light paths thereof.

FIG. 4 is a schematic, isometric view of a conventional backlight module.

### DETAILED DESCRIPTION OF PREFERRED EMBODIMENTS

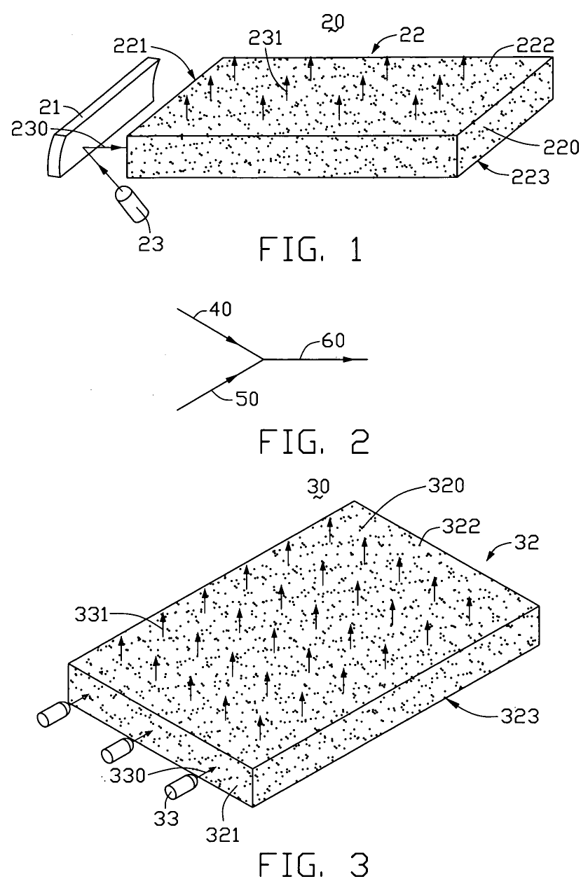

Referring to FIG. 1, a backlight module 20 according to a first embodiment of the present invention includes a reflector 21, a light guide plate 22, and a plurality of light sources 23 (only one shown). The light guide plate 22 includes a light input surface 221, a light output surface 222 adjacent to the light input surface 221, and a bottom surface 223 opposite to the light output surface 222. The light guide plate 22 includes a plurality of blue particles 220 embedded therein. Each light source 23 is an LED, which emits yellow light beams 230. The reflector 21 is disposed adjacent the light input surface 221 of the light guide plate 22, and the LEDs 23 are disposed to shine on the reflector 21.

Also referring to FIG. 2, this is a schematic diagram of mixing of different colored light beams. When blue light beams 40 mix with yellow light beams 50, white light beams 60 are the result. High purity white light beams 60 are obtained by mixing the blue and yellow light beams 40, 50 in appropriate proportions.

In operation of the backlight module 20, the yellow light beams 230 emitted from the LEDs 23 are reflected by the reflector 21 and enter the light guide plate 22 through the light input surface 221. The yellow light beams 230 subsequently are diffused by the blue particles 220. According to the light mixing theory described above, the yellow light beams 230 are converted to high purity white light beams 231, and are output from the light output surface 222 of the light guide plate 22.

In the first embodiment, the light guide plate 22 has a generally rectangular shape with a uniform thickness, and is made from transparent acrylic plastic or the like. When the light guide plate 22 is formed, the blue particles 220 are injection molded together with a base material such as molten acrylic plastic. Thereby, the light guide plate 22 with the blue particles 220 embedded therein is formed.

Various modifications and alterations are possible within the scope of the first embodiment herein. For example, the LEDs 23 may emit blue light beams, with yellow particles being embedded within the light guide plate 22. Similarly, other combinations of LED colors and particles of complementary colors may be selected.

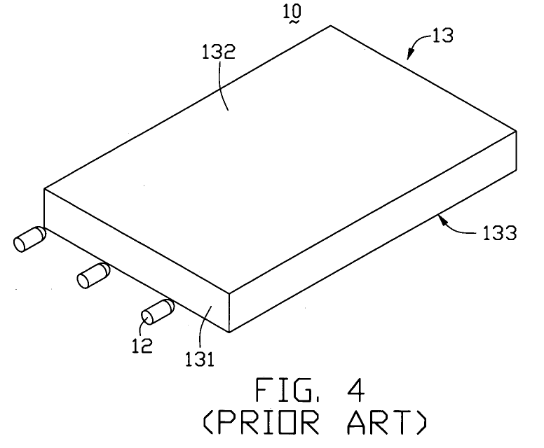

Referring to FIG. 3, a backlight module 30 according to a second embodiment of the present invention includes a light guide plate 32 and three LEDs 33. The LEDs 33 emit yellow light beams 330. The light guide plate 32 includes a light input surface 321, a light output surface 322 adjacent to the light input surface 321, and a bottom surface 323 opposite to the light output surface 322. The light guide plate 32 further includes a plurality of blue particles 320 embedded therein. The LEDs 33 are disposed adjacent to the light input surface 321 of the light guide plate 32. The LEDs 33 emit yellow light beams 330, which are complemented by the blue particles 320.

In operation, the yellow light beams 330 emitted from the LEDs 33 enter the light guide plate 32 through the light input surface 321. The yellow light beams 330 are diffused by the blue particles 320 and converted to high purity white light beams 331, which are then output from the light output surface 322 of the light guide plate 32.

Various modifications and alterations are possible within the scope of the second embodiment herein. For example, the LEDs 33 may emit blue light beams, with yellow particles being embedded within the light guide plate 32. Similarly, other combinations of LED colors and particles of complementary colors may be selected.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight module, comprising:
at least a light source for emitting light beams; and
a light guide plate comprising a plurality of colored particles embedded therein, wherein the particles have a color complementary to that of the light beams emitted by the light source, whereby the particles diffuse and convert the light beams to white light beams.

2. The backlight module as claimed in claim 1, wherein the light beams emitted by the light source are yellow.

3. The backlight module as claimed in claim 2, wherein the particles are blue.

4. The backlight module as claimed in claim 1, wherein the light beams emitted by the light source are blue.

5. The backlight module as claimed in claim 4, wherein the particles are yellow.

6. The backlight module as claimed in claim 1, wherein the light source is a plurality of light emitting diodes.

7. The backlight module as claimed in claim 1, wherein the white light beams are emitted from a light output surface of the light guide plate.

8. The backlight module as claimed in claim 1, further comprising a reflector for reflecting the light beams emitted by the light source to the light guide plate.

9. The backlight module as claimed in claim 1, wherein the particles are embedded in the light guide plate by injection molding.

10. A backlight module, comprising:
at least a light source for emitting light beams; and
a light guide plate comprising a light input surface and a light output surface adjacent to the light input surface, a plurality of colored particles being embedded in the light guide plate, the particles having a color complementary to that of the light beams emitted by the light source;
wherein the light source is disposed adjacent to the light input surface, and the colored particles convert the light beams emitted by the light source to white light beams.

11. The backlight module as claimed in claim 10, wherein the light beams emitted by the light source are yellow.

12. The backlight module as claimed in claim 11, wherein the colored particles are blue.

13. The backlight module as claimed in claim 10, wherein the white light beams are emitted from the light output surface of the light guide plate.

14. A backlight module, comprising:
at least a light source for emitting colored light beams; and
a light guide plate comprising a colored assembly applied thereto which defines a color complementary to that of the colored light beams emitted by the light source, so as to diffuse and convert the light beams to white light beams.

15. The backlight module as claimed in claim 14, wherein said colored assembly is evenly dispersed within the light guide plate rather than on surfaces thereof.

16. The backlight module as claimed in claim 15, wherein said colored assembly includes a plurality of particles.
